(19) United States
(12) Patent Application Publication
(10) Pub. No.: US 2010/0136259 A1
(43) Pub. Date: Jun. 3, 2010

(54) Cementitious Board Manufacture

(76) Inventors: Sam O'Keefe, Loughborough (GB); Parnika Sahay, Loughborough (GB)

Correspondence Address: Law Offices of Rita C. Chipperson, P.C., 55 Madison Ave, Suite 400, Morristown, NJ, 07960, US

(21) Appl. No.: 12/090,692

(22) PCT Filed: Oct. 17, 2006
(86) PCT No.: PCT/GB2006/050332

§ 371 Date: Sep. 11, 2008

(30) Foreign Application Priority Data
Oct. 19, 2005 (GB) 0521238.6

(51) Int. Cl. B06B 1/00; B05C 9/08; B06B 1/12

(52) U.S. Cl. 427/560; 427/600; 118/620

(57) ABSTRACT

A method of accelerating the setting reaction of calcium sulphate hemihydrate and water comprises the steps of mixing water and calcium sulphate hemihydrate to produce a slurry, adding an accelerator to said mixture, and applying ultrasonic energy to said mixture. Application of ultrasound to the plaster slurry accelerates crystallization and thus reduces the setting time. A further benefit is reduced density of the wall boards.

### CROSS-REFERENCE TO RELATED APPLICATIONS

This application claims the benefit of and is a national phase filing of the PCT patent application entitled “Cementitious Board Manufacture” having International Application No. PCT/GB2006/050332, filed Oct. 17, 2006, which claims the benefit of the Great Britain patent application having application no. 0521238.6, filed Oct. 19, 2006, both of which are hereby incorporated by reference in their entirety as if fully set forth herein.

### BACKGROUND OF THE INVENTION

1. Field of the Invention

This invention relates to the manufacture of cementitious board in which a slurry of cementitious material, commonly gypsum plaster, is deposited between two facing lining sheets and formed to a desired width and thickness prior to setting and drying. The process is normally carried out continuously and at high linear speed.

2. Description of the Relevant Art

To manufacture gypsum board, an aqueous slurry of calcined gypsum (calcium sulphate hemihydrate) is continuously spread between upper and lower paper sheets. The product formed is then continuously conveyed on a moving belt until the slurry has set. The strip or sheet is then dried until the excess water in the gypsum board has evaporated. In the production of gypsum wallboard, it is known to add various substances to the slurry to enhance the production process or the board itself. For example, it is usual to lighten the weight of the slurry by incorporating foaming agents to provide a degree of aeration which lowers the density of the final wallboard.

It is also known to decrease the setting time of the calcined gypsum slurry by incorporating gypsum set accelerators. Freshly ground gypsum (also known as a gypsum set accelerator) has a relatively short shelf life. The loss of acceleration efficiency of conventional accelerator materials is also exacerbated when the accelerator is exposed to heat and/or moisture.

To combat this loss of efficiency, it is known to coat the accelerator particles with, for example, sugar or a surfactant.

Accordingly, there is a need for a gypsum set accelerator or method of accelerating the set time of the gypsum slurry which alleviates the aforementioned problems.

### BRIEF SUMMARY OF THE INVENTION

According to the present invention, there is provided a method for accelerating the setting reaction of calcium sulphate hemihydrate and water comprising mixing water and calcium sulphate hemihydrate to product a slurry, adding an accelerator to said mixture, and applying ultrasonic energy to said mixture.

The ultrasonic energy may be applied for a time of less than 10 seconds.

The accelerator may be hydrated calcium sulphate.

The accelerator may be a chemical accelerator.

The chemical accelerator may be potassium sulphate (K₂SO₄).

The slurry may be formed within a mixer and deposited via a mixer outlet onto paper so as to form gypsum plasterboard, said paper being located on a conveyor.

The ultrasonic energy may be applied to the slurry when the slurry is located in the mixer outlet.

The ultrasonic energy may be applied to the slurry once it is deposited on the paper conveyor.

The ultrasonic energy may be applied using a radial shaped ultrasonic horn positioned at the exit mouth of the mixer outlet.

The ultrasonic energy may be applied directly to the slurry in the mixer.

The ultrasonic energy may be applied directly to the slurry in the mixer via probes inserted into the slurry contained within the mixer.

The ultrasonic energy may also be applied via the rotor in the mixer.

Also according to the present invention there is provided apparatus for manufacturing gypsum wall board comprising a mixer for combining calcium sulphate hemihydrate and water, a mixer outlet for depositing the gypsum slurry onto paper mounted onto a conveyor, wherein said mixer outlet comprises means for supplying ultrasonic energy to the slurry as it passes through said mixer outlet.

Said mixer outlet may comprise a tubular shaped ultrasonic horn.

Advantageously, the application of ultrasonic energy together with a known accelerator provided a decreased setting time and therefore a more efficient plasterboard manufacturing process. The application of ultrasonic accelerator in to the mixer has also surprisingly alleviated material build up in the mixer. This is caused by the vibration produced by the application of ultrasonic energy to the mixer. In particular, the combination of the use of ultrasonic energy in combination with a known gypsum accelerator has provided surprisingly goods results with the amount of particulate or chemical accelerators needed being reduced.

### BRIEF DESCRIPTION OF THE SEVERAL VIEWS OF THE DRAWINGS

Embodiments of the invention will now be described with reference to the accompanying drawings in which:

FIG. 1 is a fragmentary diagrammatical view of a longitudinal section of a gypsum board manufacturing line.

FIG. 2 is an example of a shape of a mixer outlet according to an embodiment of the present invention.

FIG. 3 is a diagrammatic view of a mixer outlet in the shape of a radial horn according to a further embodiment of the present invention.

FIG. 4 is a diagrammatical section of a mixer with ultrasonic probes.

FIG. 5 is a diagrammatical section of a mixer with an ultrasonic rotor according to a further embodiment of the invention.

### DETAILED DESCRIPTION OF THE INVENTION

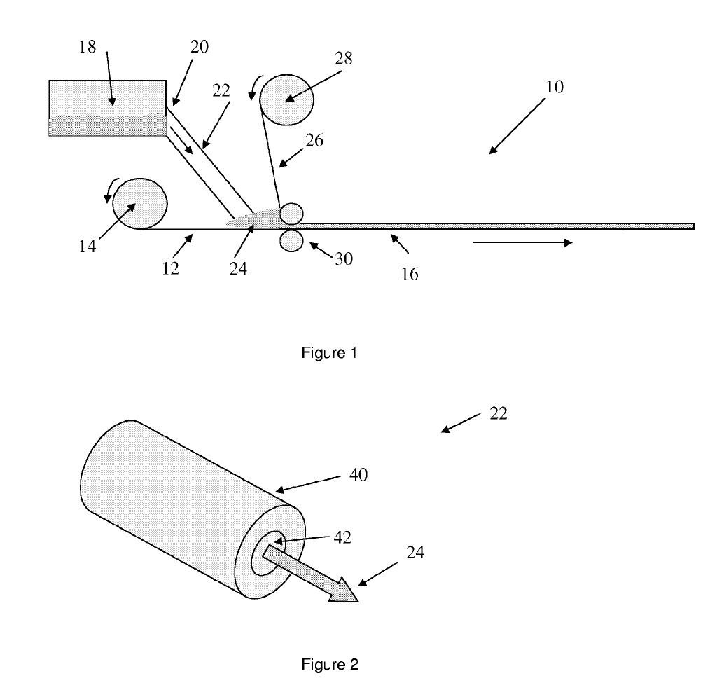

Referring to FIG. 1, a first layer of paper 12 is fed from a roll 14 onto a conveyor or belt 16. A storage mixer 18 contains a slurry of calcium sulphate hemihydrate and water. This storage mixer 18 is provided with an outlet 20 connected to a conduit 22. A meter is connected to said conduit 22 for measuring and controlling the amount of stucco fed through the conduit 22.

Additives are added to the storage mixer 18. Such additives may comprise retarders (e.g., proteins, organic acids), visocity modifying agents (e.g., superplasticisers), anti-burning agents, boric acid, water-resisting chemicals (e.g., polysiloxanes, wax emulsions), glass fibers, fire-resistance enhancers (e.g., vermiculite, clays and/or fumed silica), polymeric compounds (e.g., PVA, PVOH) and other conventional additives imparted in known quantities to facilitate manufacturing such as starch.

The storage mixer 18 is provided with an outlet 20 to deliver its combined contents in the form of slurry onto the paper 12.

This slurry mixture is then delivered through an outlet pipe 22 onto the paper 12 provided on the moving belt 16.

An additive such as starch is added to the slurry stream 24 in the mixer and a further layer of paper 26 is provided over its upper surface from a roll 28. The slurry is therefore sandwiched between two sheets of paper or cardboard 12 and 26. These two sheets become the facing of the resultant gypsum board.

The thickness of the resultant board is controlled by a forming station 30, and the board is subsequently prepared by employing appropriate mechanical devices to cut or score, fold, and glue the overlapping edges of the paper cover sheets 12 and 26. Additional guides maintain board thickness and width as the setting slurry travels on the moving conveyor belt. The board panels are cut and delivered to dryers to dry the plasterboard.

In the current embodiment of this invention, the conduit 22 may be replaced by a ring shaped radial horn through which the slurry may be fed to the slurry stream 24 and, during transit through the conduit, the ultrasonic energy may be delivered.

Referring to FIG. 2, the conduit 22 may be constructed in the form of a metallic ultrasonic radial horn with outer metallic tubing 40 and inner bore 42. The slurry 24 passes through the conduit 22 where ultrasonic energy is imparted as it forms the slurry stream on the paper 12.

Advantageously, the use of ultrasonic energy applied to the gypsum slurry accelerates the setting time of the gypsum by causing accelerated crystallization.

It is understood that when the amount of ultrasonic energy applied to the gypsum slurry exceeds the natural forces holding together the molecules, cavitation occurs.

The implosion of the cavitation bubbles produces short lived hot spots within the slurry. The collapse of some of the bubbles within the slurry enable nucleation sites to occur thus allowing accelerated crystallization.

This has the added advantage of making the slurry outlet nozzle a self cleaning delivery unit due the vibration produced by the ultrasonic energy. The vibrations at the mixer outlet also allow the slurry to be spread evenly across the moving conveyor.

In one embodiment of this invention, the conduit 22 may be replaced by a wide mouthed tubular ultrasonic horn through which the slurry may be fed to the slurry stream 24 and, during transit through the conduit, the ultrasonic energy may be delivered.

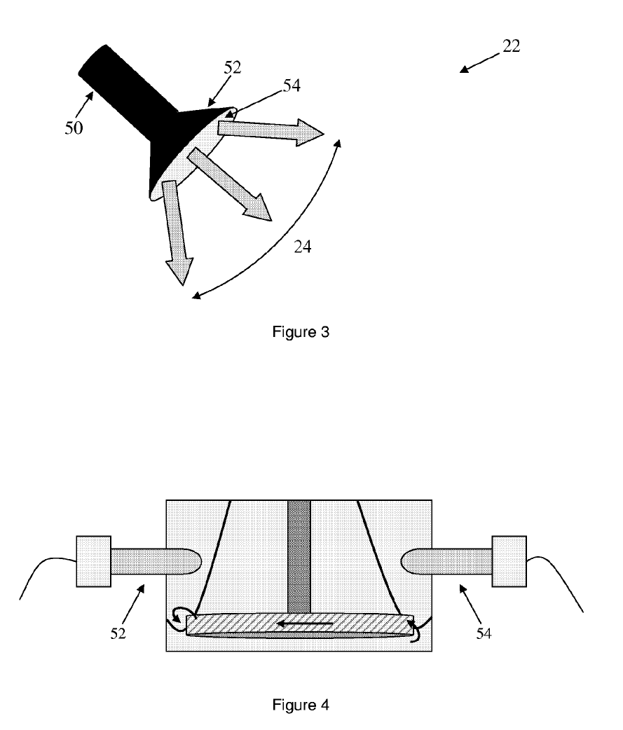

Referring to FIG. 3, the conduit 22 may be constructed in the form of a metallic ultrasonic radial horn with tubular outer metallic tubing 50 connected by some means to a conical section 52, thereby forming a wide mouthed slurry output bore 54. The slurry 24 passes through the conduit 22 where ultrasonic energy is imparted as it forms the slurry stream on the paper 12. Also, advantageously, by using a wide mouthed design of ultrasonic horn as the mixer outlet, the slurry stream on the paper 12 may be more uniformly distributed and less reliant on the use of additional mechanical vibration apparatus.

Referring now to FIG. 4, a pair of ultrasonic probes 52, 54 could alternatively be inserted into the mixer chamber 18 itself. The probes 52 and 54 advantageously act as a method for preventing mixer blockage by providing vibration to the slurry mixture.

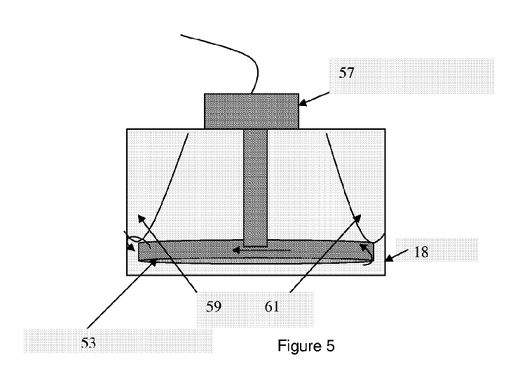

Referring to FIG. 5, the rotor 53 of the mixer is itself provided with ultrasonic energy via a generator 57. The rotor is essentially a conventional rotor but additionally provided with ultrasonic energy which it can impart to the gypsum slurry mixture fed into the mixer chamber 18.

The following example results further illustrate the present invention but should not be construed as limiting its scope.

With reference to the examples:
The slurry was made using stucco of different water gauges including 70, 80 and 90 wt % of stucco (no additives) to obtain different viscosities.
The different slurries with the different water gauges were insonated with an ultrasonic probe (at a fixed frequency of 20 kHz) for different intervals, including 2, 3, 5, 10, 15 and 20 seconds.
The set time for each insonation was measured using a Vicat set test.
To determine the effect of foam on the insonation, different slurries with different addition levels of foam were tested in the same manner as explained above for the unfoamed slurries. In this case, the water gauges were kept constant and the foam addition level altered.
Both sets of examples (using unfoamed and foamed slurries) were repeated using different ultrasonic probes with different power outputs (1 kW and 1.5 kw).
The examples were repeated with the use of ultrasound in combination with particulate accelerator, Ground Mineral Nansa (GMN) and a chemical accelerator, potassium sulphate.

### EXAMPLE 1

Prisms were made using 1000 g of stucco at three different water gauges of 70, 80, and 90 wt % of stucco. Ultrasonic energy was applied to the slurry for 3, 5 and 10 seconds using an ultrasonic probe with a power output of 1 kW. A large high-speed blender was used to mix the stucco and water for a dispersion time of 5 seconds. The water used remained at a constant temperature of 40° C. No foam was added to the slurry in this case.

TABLE 1

| | | | | Difference | | Average |
|---|---|---|---|---|---|---|
| | Water | Initial Set | Final Set | in Set | Average | Compressive |
| Insonation Time | Gauge | Times | Times | Time | Density | Strength |
| (seconds) | (wt %) | (minutes) | (minutes) | (minutes) | (kg/m3) | (MPa) |
| 0 | 70 | 8.10 | 9.45 | | 1080 | 12.7 |
| 10 | 70 | 4.50 | 7.00 | −2.45 | 1078 | 14.6 |
| 0 | 80 | 8.00 | 9.20 | | 1004 | 10.4 |
| 3 | 80 | 6.56 | 7.57 | −2.03 | 994 | 10.9 |
| 0 | 80 | 8.35 | 10.10 | | 995 | 9.9 |
| 5 | 80 | 6.20 | 8.20 | −2.30 | 990 | 10.3 |
| 0 | 80 | 8.15 | 9.45 | | 986 | 9.6 |
| 10 | 80 | 5.50 | 7.13 | −2.32 | 969 | 10.9 |
| 0 | 90 | 8.00 | 9.50 | | 913 | 8.2 |
| 3 | 90 | 6.57 | 8.00 | −1.50 | 921 | 8.6 |
| 0 | 90 | 8.30 | 9.30 | | 959 | 8.0 |
| 5 | 90 | 6.38 | 7.40 | −2.30 | 927 | 9.5 |
| 0 | 90 | 8.30 | 10.15 | | 912 | 8.4 |
| 10 | 90 | 6.37 | 8.00 | −2.15 | 917 | 8.8 |

### EXAMPLE 2

Tests were carried out to determine the effect of ultrasonic acceleration on foamed slurries. Prisms were made using 1000 g of stucco with a water gauge of 90 wt % of stucco. A foam generator was used to produce the foam to be added to the stucco blend. The foam generator was set to have an airflow rate of 2.5 I/min, foam flow rate of 0.25 l/min, and a foam concentration of 0.3%. To produce the slurry mix, a large blender was used on low speed for a total dispersion time of 10 seconds. The 1 kW ultrasonic probe was used at insonation times of 3, 5 and 10 seconds to accelerate the set of the gypsum slurry.

The stucco and water was mixed in a large batch mixer for 3 seconds before the foam was added to the blend and mixed for a further 7 seconds to produce samples 1 and 2. In the case of samples 3 and 4, stucco was mixed with water for 3 seconds before the foam was added and mixed for a further 4 seconds.

RESULT TABLE 2

| | | | Difference | | Average |
|---|---|---|---|---|---|
| Insonation | Initial Set | Final Set | in Set | Average | Compressive |
| Time | Times | Times | Time | Density | Strength |
| (seconds) | (minutes) | (minutes) | (minutes) | (kg/m3) | (MPa) |
| 0 | 11.00 | 13.00 | | 828 | 5.19 |
| 3 | 9.27 | 10.20 | −3.20 | 812 | 4.20 |
| 0 | 11.45 | 13.15 | | 723 | 2.99 |
| 3 | 10.58 | 11.50 | −2.05 | 607 | 2.17 |
| 0 | 8.30 | 10.30 | | 776 | 4.62 |
| 5 | 6.15 | 7.15 | −3.15 | 755 | 2.35 |
| 0 | 10.15 | 12.00 | | 781 | 4.88 |
| 5 | 7.20 | 8.20 | −4.20 | 715 | 3.82 |
| 0 | 12.15 | 13.00 | | 735 | 3.88 |
| 10 | 8.36 | 9.30 | −4.10 | 714 | 2.65 |
| 0 | 10.15 | 12.00 | | 807 | 4.71 |
| 10 | 7.16 | 7.50 | −4.50 | 753 | 2.72 |

### EXAMPLE 3

To compare the set times obtained with particulate accelerator as opposed to solely ultrasonic energy, prisms were made to test the effect of ultrasound on particulate accelerator (GMN). In this case, no foam was added and a water gauge of 90 wt % of stucco with a water temperature of 40° C. was used. A large high-speed blender was used to mix the stucco and the GMN with water for a 5 second dispersion time. GMN was hand mixed into dry stucco powder for 30 seconds before making the slurry in the blender.

RESULT TABLE 3

| | | | | | Difference | | Average |
|---|---|---|---|---|---|---|---|
| | Insonation | | Initial Set | Final Set | in Set | Average | Compressive |
| | Time | % GMN | Time | Time | Time | Density | Strength |
| | (seconds) | (wt %) | (minutes) | (minutes) | (min) | (kg/m3) | (MPa) |
| control | 0 | 0.5 | 3.00 | 3.45 | | 905.89 | 8.33 |
| | 3 | 0.5 | 2.12 | 3.00 | −0.45 | 852.52 | 4.23 |
| | 5 | 0.5 | 2.24 | 3.00 | −0.45 | 815.20 | 5.65 |
| | 10 | 0.5 | 1.50 | 2.48 | −1.37 | 829.94 | 4.66 |
| control | 0 | 0.1 | 5.30 | 6.15 | | 904.24 | 8.63 |
| | 3 | 0.1 | 4.30 | 5.30 | −1.25 | 880.61 | 8.55 |
| | 5 | 0.1 | 3.45 | 4.40 | −2.15 | 876.04 | 7.32 |
| | 10 | 0.1 | 3.50 | 4.54 | −2.01 | 892.16 | 7.37 |
| control | 0 | 0 | 8.50 | 11.00 | | 903.85 | 6.92 |
| | 10 | 0 | 4.30 | 5.20 | −6.20 | 921.21 | 11.00 |

### EXAMPLE 4

Non-foamed slurry was insonated using a higher power probe that could draw 1.5 kW compared with the 1 kW power (that the previous probe was capable of).

1000 g of stucco with a water gauge of 90 wt % (water temperature of 40° C.) was again mixed in a high-speed blender for 5 seconds to produce the samples.

TABLE 4

| | | | Difference in Set |
|---|---|---|---|
| Insonation Time | Initial Set Time | Final Set Time | Times |
| (seconds) | (minutes) | (minutes) | (minutes) |
| 0 | | 10.30 | −0.30 |
| 2 | 7.30 | 10.00 | |
| 0 | 7.45 | 9.25 | −3.05 |
| 15 | 4.30 | 6.20 | |
| 0 | 8.00 | 9.15 | −4.25 |
| 20 | 4.15 | 5.30 | |

### EXAMPLE 5

Non-foamed samples with two addition levels (0.06 and 0.1 wt %) of potassium sulphate (chemical accelerator) were insonated using a higher powered probe (1.5 kw) for different intervals to determine whether ultrasonic cavitation could be used in conjunction with potassium sulphate to further accelerate the set time of gypsum slurry.

TABLE 5

| | | Initial | Final | Difference | | |
|---|---|---|---|---|---|---|
| Insonation | Potassium | Set | Set | in Set | | Compressive |
| Time | Sulphate | Time | Time | Time | Density | Strength |
| (seconds) | (wt %) | (minutes) | (minutes) | (minutes) | (kg/m³) | (MPa) |
| 0 | 0 | 7.56 | 10.56 | −1.41 | 927.06 | 8.68 |
| 2 | 0 | 7.00 | 9.15 | | 919.40 | 8.38 |
| 0 | 0.06 | 7.12 | 8.12 | −1.53 | 914.61 | 8.31 |
| 2 | 0.06 | 4.40 | 6.59 | | 909.86 | 8.72 |
| 0 | 0.06 | 5.47 | 7.38 | −1.39 | 910.10 | 8.03 |
| 3 | 0.06 | 4.06 | 6.39 | | 908.97 | 8.18 |
| 0 | 0.06 | 5.59 | 8.20 | −2.00 | 910.81 | 8.42 |
| 10 | 0.06 | 5.25 | 6.20 | | 916.53 | 9.08 |
| 0 | 0.1 | 6.18 | 7.56 | −1.19 | 922.73 | 8.42 |
| 2 | 0.1 | 5.25 | 6.37 | | 914.02 | 8.53 |
| 0 | 0.1 | 4.58 | 7.06 | −1.56 | 917.63 | 8.22 |
| 3 | 0.1 | 4.58 | 5.50 | | 921.49 | 8.67 |
| 0 | 0.1 | 5.57 | 7.39 | −2.09 | 902.00 | 8.32 |
| 10 | 0.1 | 4.35 | 5.30 | | 900.25 | 8.72 |

As seen in table 5, the application of ultrasound energy in combination with a chemical accelerator (potassium sulphate) produces a substantial increase in set time. This particular combination of ultrasound energy and chemical accelerator has been found to be more effective in reducing the setting time of the gypsum slurry than either method on its own.

Table 6 is a list of results obtained from ‘on plant’ trials using ultrasound according to the present invention to accelerate the setting of gypsum.

Table Of Results For Plant Trials Using Ultrasound To Accelerate The Setting Of
Gypsum Products

| | | | Final | Avg | Difference | |
|---|---|---|---|---|---|---|
| Date | Description | Trial | set | final set | (minutes) | Notes |
| Oct. 05, 2005 | Control | 1 | 3.20 | 3.15 | −1.10 | |
| | Control | | 3.20 | | | |
| | Control | | 3.20 | | | |
| | Control | | 3.10 | | | |
| | Control | | 3.00 | | | |
| | Control | | 3.20 | | | |
| Oct. 05, 2005 | Uls on line radial horn | 2 | 2.50 | 2.45 | | |
| | circumference only | | | | | |
| | Uls on line radial horn | | 2.40 | | | |
| | circumference only | | | | | |
| Oct. 05, 2005 | Control | 2a | 3.20 | 3.30 | −0.20 | |
| | Control | | 3.40 | | | |
| | Uls on line radial horn | | 3.10 | 3.10 | | |
| | circumference only (Natural | | | | | |
| | Gypsum) | | | | | |
| Oct. 05, 2005 | Control | 4 | 3.50 | 3.42 | | |
| | Control | | 3.20 | | | |
| | Control | | 3.55 | | | |
| | Uls through centre of radial horn | | 3.00 | 2.78 | −1.04 | |
| | into skip | | | | | |
| | Uls through centre of radial horn | | 2.55 | | | |
| | into skip | | | | | |
| | Uls 90 degree to flow underneath | | 3.15 | 3.15 | −0.27 | |
| | into skip | | | | | |
| Nov. 05, 2005 | Control | 5 | 3.10 | 2.87 | | |
| | Control | | 2.50 | | | |
| | Control | | 3.00 | | | |
| Nov. 05, 2005 | Control | 6 | 3.50 | 3.50 | 0.28 | |
| | Uls with centre blocked same | | 4.00 | 3.78 | | NB. Too much |
| | direction as flow into skip | | | | | foam present |
| | Uls with centre blocked same | | 3.55 | | | NB. Too much |
| | direction as flow into skip | | | | | foam present |
| | Control | | 3.35 | 3.45 | −1.28 | |
| | Control | | 3.55 | | | |
| | uls with centre blocked same | | 3.05 | 2.58 | | Half stream |
| | direction as flow into skip | | | | | sonicated |
| | uls with centre blocked same | | 2.30 | | | Full stream |
| | direction as flow into skip | | | | | sonicated |
| | uls with centre blocked same | | 2.50 | | | |
| | direction as flow into skip | | | | | |
| | uls with centre blocked same | | 2.45 | | | |
| | direction as flow into skip | | | | | |
| Nov. 05, 2005 | Control | 7 | 4.30 | 4.25 | −1.37 | |
| | Control | | 4.20 | | | |
| | Uls through horn (added water) | | 4.20 | ignore | | Too much water |
| | into skip | | | | | |
| | Uls through horn | | 3.25 | 3.28 | | |
| | Uls through horn into skip | | 3.20 | | | |
| | Uls through horn into skip | | 3.40 | | | |
| Nov. 05, 2005 | Control - Normal recipe into skip | 8 | 3.25 | 3.18 | | |
| | Control - Normal recipe into skip | | 3.10 | | | |
| | Control - Normal recipe into skip | | 3.20 | | | |
| | Control - no GMN or retarder | | 3.55 | 3.55 | −0.50 | Suspect some |
| | | | | | | GMN still present |
| | Uls under the horn same direction | | 3.10 | 3.05 | | |
| | as flow (no GMN or retarder) | | | | | |
| Nov. 05, 2005 | Uls under the horn same direction | | 3.00 | | | |
| | as flow into skip (no GMN or | | | | | |
| | retarder) | | | | | |
| | Control - Flushed out all GMN and | | 3.40 | 3.40 | −1.13 | |
| | no retarder | | | | | |
| | Uls under the horn same direction | | 2.25 | 2.28 | | |
| | as flow into skip (no GMN or | | | | | |
| | retarder) | | | | | |
| | Uls under the horn same direction | | 2.30 | | | |
| | as flow into skip (no GMN or | | | | | |
| | retarder) | | | | | |
| | Control - no GMN but with retarder | | 3.50 | 3.50 | −0.50 | |
| | Uls under the horn same direction | | 3.50 | 3.00 | | |
| | as flow (no GMN with retarder) | | | | | |
| | Uls under the horn same direction | | 2.50 | | | |
| | as flow into skip (no GMN but with | | | | | |
| | retarder) | | | | | |
| Nov. 05, 2005 | Control - No GMN or retarder | 9 | 3.40 | 3.67 | −1.11 | |
| | Control - No GMN or retarder | | 3.10 | | | |
| | Control - No GMN or retarder | | 2.45 | | | |
| | Control - No GMN or retarder | | 4.45 | | | |
| | Control - No GMN or retarder | | 4.45 | | | |
| | Control - No GMN or retarder | | 4.10 | | | |
| | Control - No GMN or retarder | | 4.15 | | | |
| | Control - No GMN or retarder | | 3.25 | | | |
| | Uls underneath the horn 90 | | 3.25 | 2.96 | | |
| | degree to flow (no GMN or | | | | | |
| | retarder) | | | | | |
| | Uls underneath the horn 90 | | 2.45 | | | |
| | degree to flow (no GMN or | | | | | |
| | retarder) into skip | | | | | |
| | Uls underneath the horn 90 | | 3.15 | | | |
| | degree to flow (no GMN or | | | | | |
| | retarder) into skip | | | | | |
| | Uls underneath the horn 90 | | 3.00 | | | |
| | degree to flow (no GMN or | | | | | |
| | retarder) into skip | | | | | |
| Nov. 05, 2005 | Control - No GMN or retarder | 10 | 4.10 | 4.10 | −1.33 | |
| | Uls flat head horn (no GMN or | | 3.25 | 3.18 | | Slurry bouncing off |
| | retarder) 50% of power Amp. | | | | | working face. |
| | Uls flat head horn into skip (no | | 3.10 | | | |
| | GMN or retarder) 50% of power | | | | | |
| | Amp. | | | | | |

Table 7 is a summary table of results of set time achieved during the plant trials.

| | | | Difference in |
|---|---|---|---|
| | | | Set Time |
| Date | Control | Treatment | (minutes) |
| Oct. 05, 2005 | Normal recipe | Ultrasound on-line radial horn, | −0.41 |
| | | circumference only. | |
| Nov. 05, 2005 | Normal recipe | Ultrasound on-line radial horn, | −0.18 |
| | | circumference only. | |
| Nov. 05, 2005 | Normal recipe | Ultrasound through the centre of the | −1.37 |
| | | radial horn. | |
| Nov. 05, 2005 | No | Ultrasound on-line radial horn, | −1.18 |
| | accelerator no | circumference only. | |
| | retarder. | | |
| Nov. 05, 2005 | No | Ultrasound on-line radial horn, | −0.50 |
| | accelerator | circumference only. | |
| | but with | | |
| | retarder. | | |
| Nov. 05, 2005 | No | Ultrasound flat head horn, 50% of | −1.33 |
| | accelerator no | power. | |
| | retarder. | | |

### Summary Plot Of Difference in Set Times Achieved with the Use of Ultrasound on Plant Trials

### Data Regarding Density Reduction with the Use of Ultrasound

The plots below emphasize the density reduction properties of using ultrasound.

Comparing all the controls with the ultrasonically treated samples shows that all of them have a lower density than the controls. The treated samples had a corresponding strength with regard to density. The ultrasound did not have a detrimental effect on strength but simply reduced the density. The treated samples present the same proportional change in strength with density as seen from the control samples.

The density reducing property of ultrasound is another beneficial effect.

Ultrasound could therefore also be used to aerate the slurry, allowing a reduction in water gauge or foam usage. The reduction in water gauge is of greater economic benefit, since it would mean a reduction on the energy usage. The use of ultrasound would mean the benefit of mechanically aerating the slurry and achieving the same product densities with reduced quantity of water or foam.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. A method of accelerating the setting reaction of calcium sulphate hemihydrate and water comprising the steps of:
mixing the water and the calcium sulphate hemihydrate to produce a slurry;
adding an accelerator to the slurry; and
applying ultrasonic energy to the slurry.

2. A method of accelerating the setting reaction of calcium sulphate hemihydrate and water as claimed in claim 1 wherein the slurry is formed within a mixer and deposited via a mixer outlet onto paper to form gypsum plasterboard, said paper located on a conveyor.

3. A method of accelerating the setting reaction of calcium sulphate hemihydrate and water as claimed in claim 1 wherein the accelerator is a particulate accelerator.

4. A method of accelerating the setting reaction of calcium sulphate hemihydrate and water as claimed in claim 1 wherein the accelerator is a chemical accelerator.

5. A method of accelerating the setting reaction of calcium sulphate hemihydrate and water as claimed in claim 4 wherein the chemical accelerator is potassium sulphate.

6. A method of accelerating the setting reaction of calcium sulphate hemihydrate and water as claimed in claim 2 wherein the ultrasonic energy is applied to the slurry when the slurry is located in the mixer outlet.

7. A method of accelerating the setting reaction of calcium sulphate hemihydrate and water as claimed in claim 2 wherein the ultrasonic energy is applied to the slurry after the slurry is deposited on the paper conveyor.

8. A method of accelerating the setting reaction of calcium sulphate hemihydrate and water as claimed in claim 7 wherein the ultrasonic energy is applied using a radial shaped ultrasonic horn positioned at the exit mouth of the mixer outlet.

9. A method of accelerating the setting reaction of calcium sulphate hemihydrate and water as claimed in claim 2 wherein the ultrasonic energy is applied directly to the slurry in the mixer.

10. A method of accelerating the setting reaction of calcium sulphate hemihydrate and water as claimed in claim 9 wherein the ultrasonic energy is applied directly to the slurry in the mixer via probes inserted into the slurry.

11. A method of accelerating the setting reaction of calcium sulphate hemihydrate and water as claimed in claim 1 wherein the ultrasonic energy is applied for a time of less than 10 seconds.

12. A method of accelerating the setting reaction of calcium sulphate hemihydrate and water as claimed in claim 9 wherein the ultrasonic energy is imparted to the mixer via a rotor.

13. An apparatus for manufacturing gypsum wall board comprising:
a mixer for combining calcium sulphate hemihydrate and water to create a slurry; and
a mixer outlet for depositing the slurry onto paper located on a conveyor;
wherein the mixer includes means for supplying ultrasonic energy to the slurry.

14. An apparatus for manufacturing gypsum wall board as claimed in claim 13 wherein the mixer outlet is or includes a tubular ultrasonic horn.

15. An apparatus for manufacturing gypsum wall board as claimed in claim 14 wherein the ultrasonic energy is imparted to the slurry via a mixer rotor.

16. An apparatus for manufacturing gypsum wall board as claimed in claim 15 wherein the mixer rotor is an ultrasonic horn.

17. A method of accelerating the setting reaction of calcium sulphate hemihydrate and water as claimed in claim 2 wherein the accelerator is a particulate accelerator.

18. A method of accelerating the setting reaction of calcium sulphate hemihydrate and water as claimed in claim 2 wherein the accelerator is a chemical accelerator.

19. A method of accelerating the setting reaction of calcium sulphate hemihydrate and water as claimed in claim 18 wherein the chemical accelerator is potassium sulphate.

20. A method of accelerating the setting reaction of calcium sulphate hemihydrate and water as claimed in claim 2 wherein the ultrasonic energy is applied for less than 10 seconds.

21. A method of accelerating the setting reaction of calcium sulphate hemihydrate and water as claimed in claim 3 wherein the ultrasonic energy is applied for less than 10 seconds.

22. A method of accelerating the setting reaction of calcium sulphate hemihydrate and water as claimed in claim 4 wherein the ultrasonic energy is applied for less than 10 seconds.

23. A method of accelerating the setting reaction of calcium sulphate hemihydrate and water as claimed in claim 5 wherein the ultrasonic energy is applied for less than 10 seconds.

24. A method of accelerating the setting reaction of calcium sulphate hemihydrate and water as claimed in claim 6 wherein the ultrasonic energy is applied for less than 10 seconds.

25. A method of accelerating the setting reaction of calcium sulphate hemihydrate and water as claimed in claim 7 wherein the ultrasonic energy is applied for less than 10 seconds.

26. A method of accelerating the setting reaction of calcium sulphate hemihydrate and water as claimed in claim 8 wherein the ultrasonic energy is applied for less than 10 seconds.

27. A method of accelerating the setting reaction of calcium sulphate hemihydrate and water as claimed in claim 9 wherein the ultrasonic energy is applied for less than 10 seconds.

28. A method of accelerating the setting reaction of calcium sulphate hemihydrate and water as claimed in claim 10 wherein the ultrasonic energy is applied for less than 10 seconds.

29. A method of accelerating the setting reaction of calcium sulphate hemihydrate and water as claimed in claim 17 wherein the ultrasonic energy is applied to the slurry when the slurry is located in the mixer outlet.

30. A method of accelerating the setting reaction of calcium sulphate hemihydrate and water as claimed in claim 17 wherein the ultrasonic energy is applied to the slurry after the slurry is deposited on the paper conveyor.

31. A method of accelerating the setting reaction of calcium sulphate hemihydrate and water as claimed in claim 30 wherein the ultrasonic energy is applied using a radial shaped ultrasonic horn positioned at the exit mouth of the mixer outlet.

32. A method of accelerating the setting reaction of calcium sulphate hemihydrate and water as claimed in claim 18 wherein the ultrasonic energy is applied to the slurry when the slurry is located in the mixer outlet.

33. A method of accelerating the setting reaction of calcium sulphate hemihydrate and water as claimed in claim 18 wherein the ultrasonic energy is applied to the slurry after the slurry is deposited on the paper conveyor.

34. A method of accelerating the setting reaction of calcium sulphate hemihydrate and water as claimed in claim 33 wherein the ultrasonic energy is applied using a radial shaped ultrasonic horn positioned at the exit mouth of the mixer outlet.

35. A method of accelerating the setting reaction of calcium sulphate hemihydrate and water as claimed in claim 19 wherein the ultrasonic energy is applied to the slurry when the slurry is located in the mixer outlet.

36. A method of accelerating the setting reaction of calcium sulphate hemihydrate and water as claimed in claim 19 wherein the ultrasonic energy is applied to the slurry after the slurry is deposited on the paper conveyor.

37. A method of accelerating the setting reaction of calcium sulphate hemihydrate and water as claimed in claim 36 wherein the ultrasonic energy is applied using a radial shaped ultrasonic horn positioned at the exit mouth of the mixer outlet.
